(19) United States
(12) Patent Application Publication
(10) Pub. No.: US 2007/0007305 A1
(43) Pub. Date: Jan. 11, 2007

(54) Adhesive-fluid dispenser

(75) Inventor: Klaus Becker-Weimann, Karlsruhe (DE)

Correspondence Address: BIRCH STEWART KOLASCH & BIRCH, PO BOX 747, FALLS CHURCH, VA, 22040-0747, US

(73) Assignee: Kiebchemie M.G. Becker GmbH & Co. KG, Weingarten/Baden (DE)

(21) Appl. No.: 10/570,821

(22) PCT Filed: Sep. 6, 2004
(86) PCT No.: PCT/EP04/09916

§ 371 Date: Mar. 6, 2006

(30) Foreign Application Priority Data
Sep. 4, 2003 (DE) 103 41 256.5

(51) Int. Cl. B67D 5/62

(52) U.S. Cl. 222/146.5

(57) ABSTRACT

The invention relates to an adhesive fluid dispensing device with an adhesive fluid dispensing tip to which a flow from an adhesive fluid cartridge passes, and a manually actuable adhesive fluid cartridge actuating ram. It is provided in this case that the adhesive fluid cartridge is assigned a heating cartridge for heating the adhesive fluid to a temperature sufficient for flow to pass through the adhesive fluid dispensing tip upon actuation of a ram.

The present invention relates to an adhesive fluid dispensing device.

There is a series of applications in which fluids to be used have to be filled into cartridges and then dispensed. In this regard, for example, cartridges for silicone sealing compound are known in the DIY business or small-scale craftsman's business where the cartridge has a plunger which, when placed into a correspondingly formed dispensing device, can be actuated by a ram provided thereon, so that the sealing compound flows out of a tip.

It is also already known to heat adhesive compounds, which can only adhesively bond when hot, in a device and to discharge them in the form of fluid through a dispensing syringe with the use of compressed air. However, due to the need to use compressed air, devices of this type are very expensive and are therefore unsuitable for the typical DIY person or small-scale craftsman, in particular if the device is to be used at a construction site in an as freely movable manner as possible and compressed air is not available. For this reason alone, cold adhesives are typically used there.

The object of the present invention is to provide an adhesive fluid dispensing device in which the use of adhesive compounds which can be adhesively bonded when hot is possible without compressed air being required for this.

This object is achieved by an adhesive fluid dispensing device with an adhesive fluid dispensing tip to which a flow from an adhesive fluid cartridge passes, and a manually actuable adhesive fluid cartridge actuating ram, with it being provided that the adhesive fluid cartridge is assigned a heating cartridge for heating the adhesive fluid to a temperature sufficient for flow to pass through the adhesive fluid dispensing tip upon actuation of a ram.

An essential aspect of the present invention is therefore to be seen in the fact that, in the case of adhesive fluids, which are to be applied when hot, and dispensing devices for manually actuated use, it is already sufficient, in order to obtain good adhesion results, if the adhesive fluid cartridge is primarily and/or exclusively heated by a heating cartridge arrangement, since the hot adhesive fluid which flows through the tip upon actuation of a ram suffices to heat said tip, if appropriate after prior heating by heat flux from the heating cartridge, to a temperature sufficient for flow to pass through it. This permits a very simple design of the adhesive fluid dispensing device, since heating is required only at defined locations, and therefore a simple design of an adhesive fluid dispensing device is made possible even if it is to be used for adhesive fluids, such as hot-melt adhesives, in particular PUR adhesives, which are only of low viscosity when heated sufficiently.

The dispensing tip may be and is preferably composed of readily heat-conductive material, such as metal. This not only ensures a sufficiently high thermal stability but also ensures that the dispensing tip, when being heated up, is already pre-heated by heat flux from the cartridge or heating cartridge and then, in dispensing of an adhesive fluid, is heated up to such an extent by the adhesive fluid, which is heated by the heating cartridge to a temperature sufficient for dispensing it and is forced out of the cartridge, that there is no risk of solidification in the tip. At the same time, if appropriate, there may be lower temperatures at the tip because of contact with cold or relatively cold material to be adhesively bonded.

It is particularly preferred if the dispensing tip is connected in a form-fitting manner to the adhesive fluid dispensing device or the cartridge, in particular by screwing. The provision of a form-fitting connection increases the heat contact or the heat contact surfaces and therefore contributes to the, as it were, passive heating of the metal tip in adhesive fluid cartridges.

It is particularly preferred if the actuating ram which advances the plunger in the adhesive fluid cartridge in the direction of the tip in order to bring about a discharge of the heated adhesive fluid does not act over the full surface of the plunger but rather acts only on a small surface thereon. The action over the small surface preferably takes place in the center of the cartridge. This contributes in each case individually and/or in particular jointly to only a small quantity of heat being transferred to the ram, which therefore keeps the heat losses across the ram low. This contributes, firstly, to a reduced temperature at the actuation end even if there are high temperatures within the cartridge and/or at the tip; secondly, it also improves the working safety and the handling convenience and also permits relatively long operation after the heating is switched off or, with the same heating power, shorter heating up times and/or a less strong design of the heating cartridge.

The ram may be assigned a pistol-type or pliers-type handle, which leads at the actuation end to further reduced actuating temperatures. Moreover, the handling is facilitated. The heating cartridge is usually arranged around the cartridge in such a manner that the cartridge content is heated not only from one side, but in particular from diametrically opposite sides and/or from a plurality of locations along the casing surface of the cartridge. A non-uniform heating of the cartridge content and therefore a local overheating can thereby be largely avoided.

The heating cartridge will preferably also insulate the adhesive fluid cartridge against heat losses and is designed in such a manner that it can be separated from a power supply during dispensing of the adhesive fluid. This makes it possible first of all to heat the adhesive fluid dispensing device to a temperature at which an adhesive fluid cartridge content, such as a quantity of polyurethane hot-melt adhesive or other hot-melt adhesives sufficient for certain adhesive bonds, is fully heated up to the required temperature and, after the heating, will ensure that the adhesive fluid dispensing device can readily be used without being adversely affected by power supply cords. At the same time, no heavy power supply sources, such as storage batteries and the like, have to be moved at the same time.

The invention is explained below only by way of example with reference to the drawings without the invention being restricted thereto. In the drawings

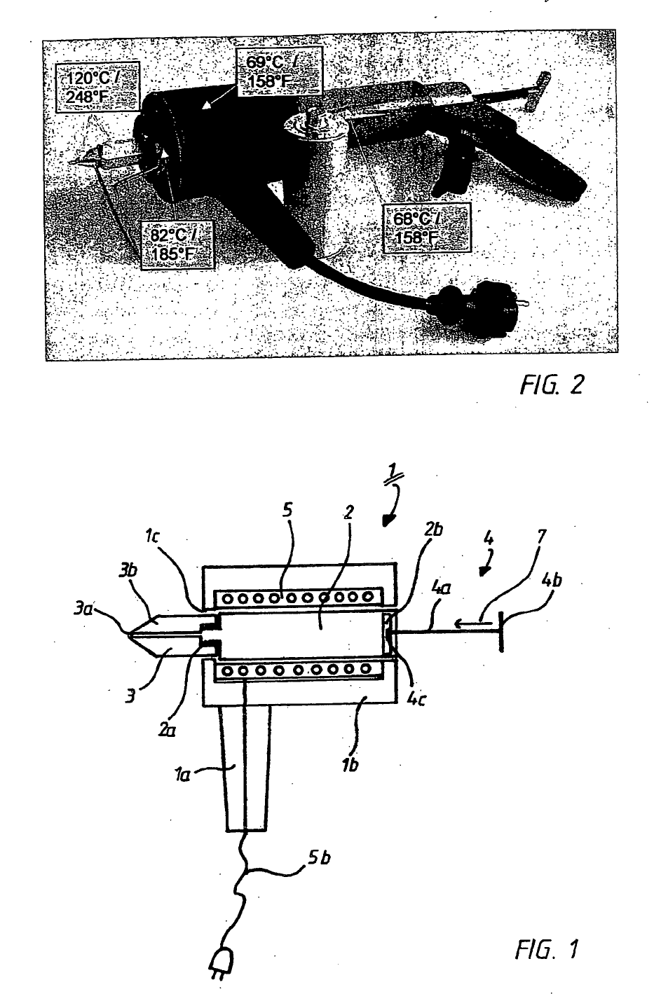

FIG. 1 shows an adhesive fluid dispensing device according to the invention, and

FIG. 2 shows the illustration of an adhesive fluid dispensing device with temperature details by way of example and with a pliers-type handle.

FIG. 1 shows an adhesive fluid dispensing device 1 with an adhesive fluid dispensing tip 3 to which a flow from an adhesive fluid cartridge 2 passes, and a manually actuable adhesive fluid cartridge actuating ram 4, the adhesive fluid cartridge 2 being assigned a heating cartridge 5 for heating the adhesive fluid to a temperature sufficient for flow to pass through the adhesive fluid dispensing tip upon actuation of a ram.

In the present case, the adhesive fluid dispensing device 1 is provided with a front holding handle 1a which is formed integrally with a covering 1b of the heating cartridge 5 and the adhesive fluid cartridge 2 situated therein. A front aperture 1c through which the adhesive fluid dispensing tip 3 protrudes is provided in the covering 1b. A guide (not shown in FIG. 1) for the adhesive fluid cartridge actuating ram 4 is provided on that side of the adhesive fluid dispensing device which faces away from the tip 3.

In the present case, the adhesive fluid cartridge 2 is a tinplate cartridge which is filled with polyurethane hot-melt adhesive which is at least largely solid in the cold state, has a screw thread 2a at its dispensing end and, on the side facing away therefrom, has a plunger 2b against which the adhesive fluid cartridge actuating ram 4 bears. The plunger 2b bears tightly without any play against the inner wall of the cartridge and is slidable therein. It seals the heated adhesive fluid at the same time against the penetration of air.

The discharge tip 3 is screwed onto the thread 2a of the adhesive fluid cartridge, as a result of which, with the cartridge fixed in the adhesive fluid dispensing device 1, said discharge tip is fixed relative to the latter and therefore to the adhesive fluid dispensing device. The adhesive fluid dispensing tip 3 is formed from metal and has a channel 3a through which the flow of adhesive fluid passes and which has a shape required for the desired application width. This may promote spraying or a planar application.

The length of the adhesive fluid dispensing tip 3 is selected in such a manner that, when the adhesive fluid heated to operating temperature flows through it, the flow can pass through it without the risk of plugs forming due to adhesive fluid cooling in the channel 3a. For this purpose, the walls 3b around the channel 3a have a sufficient thickness, with the mechanical stability being ensured at the same time. The walls may be formed in a shape, in particular hexagonal, which is readily graspable for tools, in particular to facilitate the screwing onto the adhesive fluid cartridge or release therefrom.

The adhesive fluid cartridge actuating ram 4 is formed from a metal bar 4a of sufficient length and a rear actuating crossbar 4b and acts on the adhesive fluid cartridge plunger 2b centrally over a small surface, as indicated at 4c. In order to press the plunger 2b in the direction of the arrow 7 toward the tip 3, the adhesive fluid cartridge actuating ram 4 is mounted in a manner such that it can be slidably displaced; it is also possible, as apparent in FIG. 2, for pistol-type pliers handles, which are known per se, to be used in addition to or instead of the manual actuating crossbar 4b.

The heating cartridge 5 is guided around the adhesive fluid cartridge in the form of an individual heating coil. The arrangement around the adhesive fluid cartridge casing is designed in such a manner that as uniform as possible heating of the entire adhesive fluid cartridge content takes place during heating up of the heating cartridge 5. The heating cartridge 5 is to be connected to an electric current supply via a short connecting line 5b.

The arrangement according to FIG. 1 can be used as follows.

First of all, a full adhesive fluid cartridge with adhesive fluid which is still solid is inserted into the adhesive fluid dispensing device 1 and the tip 3 is screwed on. The heating cartridge 5 is then connected to a power source via the line 5b and therefore heats to an operating temperature of, for example, 130° C. In the process, the adhesive fluid in the adhesive fluid cartridge melts uniformly from all sides without having to the concerned about local overheating. After a predetermined, short time, the line 5b can be disconnected from the power supply and the adhesive fluid dispensing device can be carried to the use location. Here, adhesive fluid can be pressed out of the tip 3 by manual actuation of the adhesive fluid cartridge actuating ram 4. In the process, the heating cartridge insulates the cartridge against heat losses and therefore at the same time constitutes a means of insulation.

The temperature values determined after heating at the adhesive fluid dispensing device can be seen in FIG. 2. It is apparent that the temperatures at the adhesive fluid dispensing device are such that the hottest exposed location is the adhesive fluid dispensing tip. If appropriate, an insulation can additionally be used which ensures that certain limit temperatures, which are prescribed, for example, for working safety reasons, are not exceeded. Even then, however, nothing changes the fact that the adhesive fluid dispensing tip 3 has a sufficiently high temperature for dispensing adhesive fluid.

After the adhesive fluid is dispensed, the cartridge can be removed, if appropriate adhesive fluid which is still present can be removed from the tip 3 by insertion of a cleaning cartridge and the adhesive fluid dispensing device 1 can be put to the side until its next use.

It is also possible to leave adhesive fluid in the cartridge and to heat it up again for subsequent use.

In a different manner than explained here, it is furthermore possible, instead of a separate adhesive fluid dispensing tip, also to provide a tip which is connected permanently to the adhesive fluid cartridge.

1-9. (canceled)

10. An adhesive fluid dispensing device with an adhesive fluid dispensing tip to which a flow from an adhesive fluid cartridge passes, and a manually actuable adhesive fluid cartridge actuating ram, the adhesive fluid cartridge being assigned a heating cartridge for heating the adhesive fluid to a temperature sufficient for flow to pass through an adhesive fluid dispensing tip upon actuation of a ram, wherein the heating cartridge is not in direct contact with the adhesive fluid dispensing tip, and the dispensing tip is composed of readily heat-conductive material.

11. The adhesive fluid dispensing device as claimed in claim 10, wherein the dispensing tip is heated substantially just by the adhesive fluid flowing out.

12. The adhesive fluid dispensing device as claimed in claim 10, wherein the dispensing tip is screwed onto a metal thread on the adhesive fluid cartridge and the dispensing device is screwed or connected in a form-fitting manner to the adhesive fluid cartridge.

13. The adhesive fluid dispensing device as claimed in claim 12, wherein the adhesive fluid cartridge is composed of metal and onto a metal thread on the dispensing device.

14. The adhesive fluid dispensing device as claimed in claim 12, wherein the adhesive fluid cartridge is composed of metal or onto a metal thread on the dispensing device.

15. The adhesive fluid dispensing device as claimed in claim 10, wherein the ram acts on the plunger.

16. The adhesive fluid dispensing device as claimed in claim 10, wherein the ram is assigned a pistol-type and pliers-type handle.

17. The adhesive fluid dispensing device as claimed in claim 10, wherein the ram is assigned a pistol-type or pliers-type handle.

18. The adhesive fluid dispensing device as claimed in claim 10, wherein the heating cartridge is arranged around the cartridge.

19. The adhesive fluid dispensing device as claimed in claim 10, wherein the heating of the cartridge content takes place from diametrically opposite sides.

20. The adhesive fluid dispensing device as claimed in claim 10, wherein the heating cartridge insulates the adhesive fluid cartridge against heat losses and is designed for disconnection from a power supply during dispensing of adhesive fluid.

21. The adhesive fluid dispensing device as claimed in claim 20, wherein power is supplied by electric current.
